(19) United States
(12) Patent Application Publication
(10) Pub. No.: US 2004/0258063 A1
(43) Pub. Date: Dec. 23, 2004

(54) Multimedia message processing

(76) Inventors: Alex Krister Raith, San Clemente, CA (US); Edwin Sandberg, Tyreso (SE); Jonas Svedberg, Lulea (SE)

Correspondence Address: COATS & BENNETT, PLLC, P O BOX 5, RALEIGH, NC, 27602, US

(21) Appl. No.: 10/807,975

(22) Filed: Mar. 24, 2004

Related U.S. Application Data
(60) Provisional application No. 60/457,449, filed on Mar. 25, 2003.

(51) Int. Cl. H04L 12/28

(52) U.S. Cl. 370/389; 370/401; 370/466

(57) ABSTRACT

An originating network, such as an originating wireless communication network, selectively performs multimedia content transcoding of outgoing multimedia messages as a function of the corresponding destination network addresses. More particular, in an exemplary embodiment, the originating network includes or has access to one or more databases that are accessed to determine whether transcoding is desired. Such information may comprise a listing of destination addresses, e.g., email addresses, or particular domain identifiers, for which transcoding is desired. Moreover, such information can indicate whether default or specific transcoding formats should be used. With this approach, the originating network can transcode all, or selected multimedia content, e.g., audio, video, etc., into one or more coding formats that known or expected to be compatible with the coding formats used by the targeted destination networks.

### RELATED APPLICATIONS

This application claims priority under 35 U.S.C. § 119(e) from U.S. Provisional Application Ser. No. 60/457,449 filed on Mar. 25, 2003. This application is expressly incorporated in its entirety by reference herein.

### BACKGROUND

The present invention generally relates to communication networks that send or receive multimedia messages, and particularly relates to processing multimedia messages according to desired media formats.

Internet users routinely send emails to networked systems and devices all around the globe. The Simple Mail Transport Protocol (SMTP) typically is used to format such messages, and that protocol enables such messages to carry a variety of attachments, including multimedia attachments comprising images, audio/video clips, etc. Further, the use of standardized transport and packet protocols, i.e., the Transport Control Protocol/Internet Protocol (TCP/IP), permits disparate types of networks and devices to send such messages via the Internet.

For example, many wireless communication networks directly or indirectly couple to the Internet, and thus allow their subscribers to send and receive packet data via the Internet from properly equipped wireless devices, e.g., wireless communication terminals, such cellular radiotelephones, portable digital assistants, pagers, etc. Users outside of these networks may send emails or other message types that include multimedia content for delivery to targeted subscribers' terminals, or subscribers may originate such messages for delivery inside or outside their supporting wireless networks.

Several wireless communication networks, such as those based on Global System for Mobile communications (GSM) standards, cdma2000 standards, or other standards, include support for sending and receiving multimedia messages to and from subscriber devices. A typical wireless communication service provider's network includes one or more entities to support Multimedia Messaging Services (MMS). Such entities typically include one or more MMS Centers (MMS-Cs), which send MMS messages for delivery within the same network or to another network, and which receive MMS messages for delivery to subscribers' terminals in the network.

Complementing the transport of multimedia content by such networks, some or all of the multimedia content within those messages may be encoded or otherwise processed in a format that is native to the network type. For example, the GSM standards specify Adaptive Multi-Rate (AMR) voice coding as GSM's “native” audio encoding format. Therefore, GSM terminals originating MMS messages with audio content typically encode such content using AMR coding. Similarly, cmda2000 standards specify a native voice-coding format, which is used by cdma2000 terminals when generating multimedia audio content.

However, the cdma2000 native format (Code Excited Linear Prediction or CELP) is not compatible with the GSM native format. Thus, multimedia audio content natively formatted for GSM networks is not compatible with cdma2000 networks, and vice versa. Of course, other incompatibilities arise in MMS contexts. For example, multimedia content from sources outside a given wireless network, e.g., incoming from the Internet at large, may include content in any number of non-native formats, such as WINDOWS Media Audio (WMA), REAL Audio (RA), or other format.

In general, then, opening a wireless communication network up to multimedia content incoming from disparate sources, or originating MMS messages in one type of wireless network for delivery to a potentially different type of wireless network, presents a number of challenges. In particular, care must be taken with regard to media content compatibility for multimedia messaging services between potentially different types of networks.

### SUMMARY

The present invention comprises a method and apparatus for processing multimedia messages outgoing from an originating network. A given message may be targeted to a destination network that is compatible with the coding format of multimedia content in the outgoing message, in which case “transcoding” of such content into another coding format is unnecessary. However, the destination network may not be compatible, such as where QCELP audio content in a multimedia message is targeted for delivery to a GSM network subscriber, and in such instances, the exemplary originating network is configured to transcode the incompatible content into a format specified for the destination network. Additionally, or alternatively, the exemplary originating network may be configured to perform transcoding into a default format for certain destination addresses, e.g., transcoding into a format that is widely used in multimedia delivery, such as WINDOWS Media Audio format.

Thus, an exemplary method of processing multimedia messages outgoing from an originating network comprises selectively transcoding multimedia content in outgoing multimedia messages from a current format into a default format as a function of their destination network addresses, and sending the messages according to their destination network addresses. The originating network may comprise a wireless communication network that uses one or more native media coding formats that it selectively transcodes into one or more default formats responsive, for example, to recognizing that an outgoing message is targeted to an Internet email address.

Complementing the above embodiment, an exemplary multimedia message center for processing multimedia messages outgoing from an originating network comprises a server configured to selectively transcode multimedia content in outgoing multimedia messages from a current format into a default format as a function of their destination network addresses, and send the messages according to their destination network addresses. The multimedia message center may comprise a Multimedia Message Services Center (MMS-C) within an originating wireless communication network.

In another exemplary embodiment, an exemplary multimedia message processing method comprises sending destination address information for an outgoing multimedia message from a first entity to a second entity, receiving at the first entity a corresponding indication from the second entity as to whether multimedia content transcoding is desired for the message, selectively performing transcoding at the first entity based on the indication, and sending the message from the first entity for delivery to the destination address. Such an embodiment may be implemented by communicatively coupling a multimedia message center in the originating network to a supporting entity, such as a database server that is configured to determine whether transcoding should be performed, which may or may not be in the originating network.

Complementing the above method, an exemplary multimedia message center for processing multimedia messages outgoing from an originating network comprises a multimedia server configured to send destination address information for an outgoing multimedia message to a database server, and to receive an indication back from the database server as to whether multimedia content transcoding is desired for the message. The multimedia server may comprise a first circuit configured selectively to perform transcoding based on the indication, and a second circuit configured to send the message for delivery to the destination address.

In another exemplary embodiment, a method of processing multimedia messages outgoing from an originating network comprises forwarding an outgoing multimedia message from a first entity to a second entity, receiving the message back from the second entity at the first entity, after the second entity has subjected the message to selective transcoding of multimedia content in the message, and sending the message from the first entity for delivery to the destination address. Thus, with this configuration, the second entity, which may or may not be included in the originating network, provides selective transcoding processing for multimedia messages outgoing from the originating network.

Complementing the above method, an exemplary multimedia message center for processing multimedia messages outgoing from an originating network comprises a multimedia server configured to forward an outgoing multimedia message to a transcoding system, to receive the message back after the transcoding system has subjected the message to selective transcoding of multimedia content in the message, and to send the message from the first entity for delivery to the destination address. The transcoding system thus serves as a supporting entity that provides transcoding services for outgoing messages, and it may be included in the originating network, or it may be external to the originating network.

Of course, the above information is not limiting with respect to the present invention. Additional features and advantages are described in the following detailed description and illustrated in the accompanying figures. Those skilled in the art will recognize still further features and advantages upon reviewing the information herein.

### BRIEF DESCRIPTION OF THE DRAWINGS

FIG. 1 is a diagram of an exemplary network configured to originate multimedia messages for delivery to one or more destination networks in accordance with one or more embodiments of the present invention.

FIG. 2 is a diagram of exemplary processing logic for implementing multimedia message transcoding in accordance with one or more embodiments of the present invention.

FIG. 3 is another diagram of exemplary processing logic for implementing multimedia message transcoding in accordance with one or more embodiments of the present invention.

FIG. 4 is another diagram of exemplary processing logic for implementing multimedia message transcoding in accordance with one or more embodiments of the present invention.

FIG. 5 is another diagram of exemplary processing logic for implementing multimedia message transcoding in accordance with one or more embodiments of the present invention.

### DETAILED DESCRIPTION

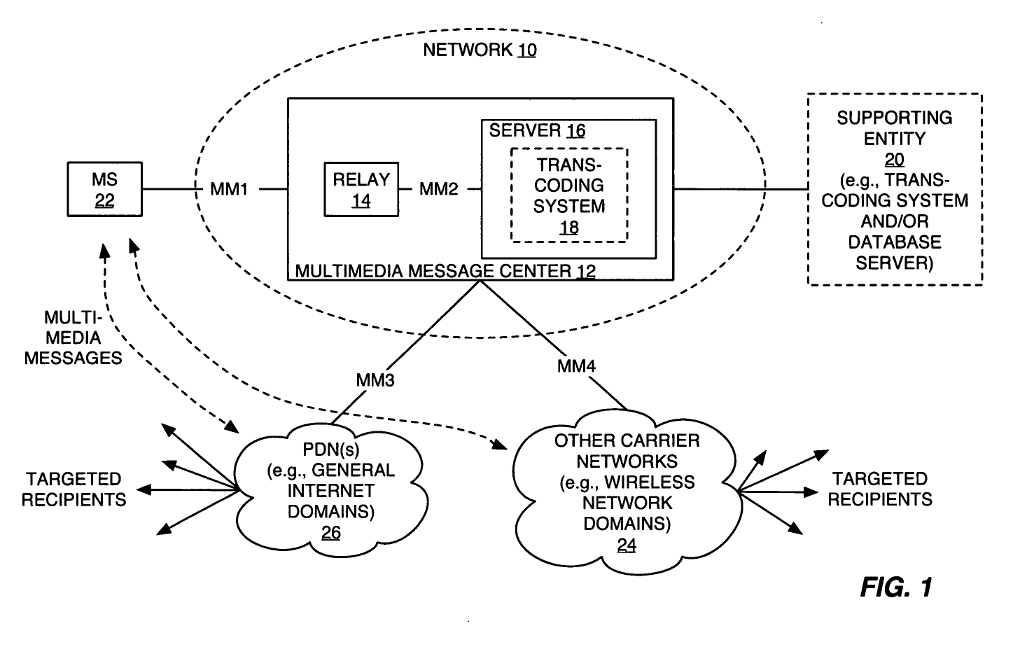

FIG. 1 is a diagram of an exemplary network 10 configured to originate multimedia messages for delivery to one or more destination networks in accordance with one or more embodiments of the present invention. Network 10 may comprise, for example, a wireless communication network, such as one configured according to Global System for Mobile communications (GSM) standards, Wideband Code Division Multiple Access (W-CDMA) standards, cdma2000 standards, etc.

Network 10 comprises a multimedia message center 12, that itself may comprise a multimedia relay 14 and a multimedia server 16. An exemplary server 16 generally comprises circuits to support handling multimedia messages, such as one or more circuits configured to send outgoing multimedia messages for delivery to the networks corresponding to their destination network addresses. Further, the exemplary server 16 includes a transcoding circuit or system 18 that is configured to support selective transcoding of multimedia content in the outgoing messages. As will be explained later herein, the transcoding system 18 may cooperate with a supporting entity 20, that may function as a transcoding database server that indicates whether transcoding is desired for a given message, or that may function as a full transcoding system (like system 18) that receives outgoing messages from the server 16, selectively transcode them, and return them to server 16 for sending them out for delivery to the destination addresses.

Thus, regardless of its particular configuration, network 10 broadly sends outgoing multimedia messages, such as messages originating from a mobile station 22, for delivery to targeted recipients communicatively coupled to one or more destination networks, such as Public Data Networks (PDNs) 26 and/or other wireless communication networks 24. PDNs 24 may comprise, for example, the Internet at large, and the other wireless networks 26 may comprise the networks of other wireless carriers, i.e., other wireless network domains, and such networks may or may not be based on the same wireless communication standards as network 10.

With the above in mind, it might be noted that while the present invention has broad applicability, certain standard documents may be helpful to the reader interested in additional details regarding MMS in the context of wireless communication networks. For example, the Third Generation Partnership Project (3GPP) initiated standardization of MMS, and that the first release of such requirements may be found in the following documents: Multimedia Messaging Service: Service aspects; Stage 1, Third Generation Partnership Project TS 22.140 Release 1999, available from www.3gpp.org/ftp/Specs/; and Multimedia Messaging Service: Functional description; Stage 2, Third Generation Partnership Project TS 23.140 Release 1999, available from www.3gpp.org/ftp/Specs/.

The Third Generation Partnership Project 2 (3GPP2) also created a set of standards directed to MMS and these are defined in the following documents; 3GPP2 MMS Specification Overview, Multimedia Messaging System Specification (X.S0016-000), MMS Stage 2, Functional Description (X.S0016-200), MMS MM1 Stage 3 Using OMA/WAP (X.S0016-310), MMS MM4 Stage 3 Intercarrier Interworking (X.S0016-340), MMS MM7 VASP Interworking, and Stage 3 Specification (X.S0016-370). The MMS standards for cdma2000 are also described in the following documents from Telecommunication Industry Association (TIA): 3GPP2 MMS Specification Overview, Multimedia Messaging System Specification (TIA-934-000), MMS Stage 2, Functional Description (TIA-934-200), MMS MM1 Stage 3 Using OMA/WAP (TIA-934-310), MMS MM4 Stage 3 Intercarrier Interworking (TIA-934-340) and MMS MM7 VASP Interworking, Stage 3 Specification (TIA-934-370). The multimedia formats and codecs are described in 3GPP TS 26.140 for GSM and in C.S0045 for cdma2000.

In the wireless context, MMS evolved from the text-based Short Message Services (SMS) systems, but uses the Wireless Application Protocol (WAP). Those skilled in the art will recognize WAP as a protocol that permits mobile devices to communicate with Internet servers via mobile radio communications networks, such as network 10. Because the typical mobile device display is much smaller (typically, 150×150 pixels) than computer monitor displays (typically, at least 640.times.480 pixels), a website designed to be displayed on a computer monitor generally cannot be displayed on a mobile device with any practicality. Also, mobile devices usually have considerably less processing power than personal computers.

Accordingly, WAP was developed to allow mobile devices to access special Internet sites that are designed to be displayed on a mobile device and to provide an interface between the mobile device and the Internet. A user of a WAP enabled mobile device can access the Internet via the mobile radio communications network to shop, get stock quotes, get traffic and weather reports, etc.

MMS is a standard for sending and receiving multimedia messages. The multimedia messages can include any combination of formatted text, images, photographs, audio and video clips. The images can be in any standard format such as GIF and JPEG. Video formats such as MPEG4 and audio formats such as MP3 and MIDI also are supported by MMS. The MMS specifications describe the format for the MMS messages from a MMS Relay Server to a “User Agent” at the mobile device, e.g., software running on a processor included in mobile terminal 22, with the mandatory steering field and the sequence of such messages detailed in the following documents: Multimedia Messaging Service: Service aspects; Stage 1, Third Generation Partnership Project TS 22.140 Release 4 (V4. 1.0), available from www.3gpp.org/ftp/Specs/; and Multimedia Messaging Service: Functional description; Stage 2, Third Generation Partnership Project TS 23.140 Release 4 (V4.2.0), available from www.3gpp.org/ftp/Specs/.

The typical format of a MMS message comprises headers that provide the routing information and addresses of the recipients and senders of the MMS message, i.e., originating and destination address information. Further, a message body includes the multimedia message content, which may comprise different types or portions of multimedia content. By way of non-limiting example, such content may include: image content represented according to one or more image coding formats (e.g., JPEG); formatted or plain text; audio content represented according to one or more audio coding formats (e.g., MP3, WAV, AMR, etc.); video content represented according to one or more video coding formats (e.g., MPEG); and, optionally, may include a “presentation file” that presents the multimedia content to the targeted recipient(s) of the multimedia message.

As with other types of multimedia content, the audio portion of a MMS message may be stored in various formats. Two major variations in audio storage comprise storing audio content in its sampled format, or storing it in an encoded file format. Either format ultimately represents a waveform (or multiple waveforms) in time that may be used to regenerate audio output. For transmission efficiency in view of the limited air interface bandwidth, wireless networks typically transmit audio in an encoded format. For example, typical wireless network voice encoders (vocoders) include AMR, W-AMR for GSM/WCDMA and EVRC, QCELP and SMV for cdma2000.

More specifically, 3GPP MMS specifies AMR according to 3GPP/TS26.071. A given GSM or WCDMA mobile station also may be configured to support WB-AMR according to 3GPP/TS26.171, ITU-T G722.2, which is a higher quality version of the basic AMR vocoder. The common speech coders used for regular speech service in cdma2000 include EVRC (IS-127) and QCELP (IS-733). A codec specified but not deployed yet is SMV (IS-893). There are advantages to using a given network's “native” vocoders for MMS in terms of minimizing additional terminal complexity. However, the native vocoding format of one network may be incompatible with, or otherwise unsupported by, another type of network. Although the media type “encoded speech” is one of the most important differences in media types, other media types may also be different that incompatibilities may arise. Furthermore, although the example above is directed to GSM/WCDMA and cdma2000, there are other wireless and wired technologies that also may define a native MMS service for which there are incompatible media types.

Transcoding in at least one exemplary embodiment of the present invention comprises changing the coding format of multimedia content from a current format into one or more new formats. For example, AMR-encoded audio content in a message originating from a GSM network may be transcoded to CELP-encoded audio upon recognition that the message is targeted for delivery to a cdma2000 network subscriber. Conversely, the audio content in a message outbound from cdma2000 network that is destined for delivery to a GSM network subscriber may be transcoded from CELP to AMR. Of course, other coding formats may be used (MP3, WMA, etc.), and such transcoding may additionally, or alternatively, be applied to other types of message content, such as video.

Regardless, because of their potentially large sizes, MMS messages generally are sent using dedicated sessions or connections between network 10 and mobile station 22. For example, MMS messages can be sent over a dedicated traffic channel (voice or data) established between network 10 and mobile station 22. Those skilled in the art will thus recognize that network 10 as illustrated in FIG. 1 will in actuality include additional entities supporting over-the-air and intra-network communications. Such entities may include but are not limited to a Radio Access Network (RAN) comprising radio base stations, controllers, etc., and a Packet Core Network (PCN), which may include MMS-C 12, or which otherwise communicatively couples MMS-C 12 to the mobile station 22.

As with SMS messages, MMS messages can be directed to particular recipients using the recipients' Mobile Station ISDNs (MSISDNs). MSISDNs provide information regarding a recipient's country code, a national destination code that identifies the recipient's wireless network operator (domain), and a code identifying the recipient's wireless network Home Location Register (HLR). While not germane to understanding the inventive transcoding detailed herein, those skilled in the art will recognize that each recipient's HLR stores information useful in routing, such as identification of the recipient's current Visitor Location Register (VLR) in “roaming” situations.

In any case, MMS messages typically are routed to the recipients through the Internet using Simple Mail Transport Protocol (SMTP). In one or more embodiments of the present invention, the MSISDNs are submitted to an ENUM database, which identifies the wireless network carrier domain, e.g., by identifying a targeted MMS server in the domain based on the MSISDN of a message recipient. In more detail, the acronym ENUM refers to the Internet Engineering Task Force (IETF) protocol that takes a complete international telephone number and resolves it into a series of Uniform Resource Locators (URLs) using a Domain Name System (DNS) based architecture. A country code in the MSISDN could be used to route the message to an ENUM server in that country. Each country may maintain a database for routing MMS messages to users in that country. ENUM thus provides a mechanism for converting MSISDN numbers to URL addresses in the Domain Name System (DNS) environment.

Thus, transcoding system 18 of server 16 may be configured to identify, or otherwise recognize, the destination network address of an outgoing multimedia message based on submitting the MSISDN(s) of the targeted message recipient(s) to an ENUM database that includes listing data associating particular MSISDNs with particular wireless network domains. Identification of the wireless network domain or domains targeted by an outgoing message thus enables determination of whether transcoding of any or all multimedia content in the message should be performed, e.g., a carrier list may be accessed that identifies the wireless network domains for which transcoding is desired. Further, any carrier listing database also may specify the specific coding formats that multimedia content should be transcoded to for delivery to each particular wireless network domain.

Where the destination network uses a different technology than used by network 10 as the originating network, MMS-C 12 can be programmed to recognize which particular technology is associated with the particular destination network targeted by the outgoing message. For example, after the ENUM conversion from MSISDN (or MIDN for 3GPP2 based technology) to one or more URL addresses, the realm (domain) of the URL may be entered into a look-up table that is programmed to output the type of technology associated with the destination network. If the URL indicates a different technology and the outgoing message includes content in a coding format that is known or assumed not to be compatible with the destination network, the MMS-C 12 can convert the media type format into format that is supported by the destination network.

The MMS-C 12 may be equipped with a table or a list of formats not supported by particular networks, e.g., by other wireless carrier domains and/or it may be equipped with or have access to a database that identifies the format or formats specifically desired by particular destination networks. Such format specifications may include specified formats for different types of multimedia content, e.g., audio, video, etc. For example, assume that network 10 is a cdma2000 network and that mobile station 22 sends a multimedia message destined for a GSM network subscriber.

The message is received in the MMS-C 12, which accesses one or more databases to determine that the message is targeted to a GSM-based network. The MMS-C 12 then examines the content in the message, and in particular the MIME types included. If the MIME types indicate that an element in the message currently is coded according to any one of the native cdma2000 vocoders, the MMS-C 12 transcodes such multimedia content into a vocoder format used by GSM systems (or into format(s) specifically listed for the particular GSM network targeted by the message.

In the more general case, the MMS-C 12 examines all media types in the outgoing message and their corresponding formats and uses database information to determine which of the formats needs conversion and to which format(s) such transcoding conversions should be made. As will be explained in detail later herein, MMS-C 12 may make selective transcoding determinations, and may perform the transcoding operations. However, one or both of those functions may be offloaded to one or more supporting entities, and the supporting entities may even be provided outside of network 10 by third parties. In such instances, the supporting entities may be accessible to MMS-C 12 via the Internet.

As noted above, an ENUM based server could be made accessible to server 16 (and any other such servers in network 10), to support the conversion of MSISDN information in outgoing multimedia messages into destination email addresses. Of course, identification of destination network addresses based on ENUM database processing of recipient mobile telephone identification information in the outbound messages represents just one of several exemplary approaches to determining on a selective basis whether and what type of transcoding is desired for individual ones of the multimedia messages being sent from MMS-C 12.

In another exemplary embodiment, server 16 stores or has access to a database that provides network information. Such a table would allow, for example, a wireless network subscriber to specify the multimedia server address of the subscriber's Internet Service Provider (ISP), rather than the address of a multimedia server in the subscriber's wireless service provider. That requires the wireless service provider to update the relevant database so that the user's MSISDN number points to the address of the MMS server belonging to the ISP. Not only does the user's mobile telephone service provider need to make this update, but also all other MMS servers must update their internal databases so that all of the MMS servers are aware of the new routing address to the user's ISP.

Regardless of how the particular destination network routing information is obtained, the exemplary MMS-C 12 includes or has access to at least one database that supports selective transcoding determinations. That is, MMS-C 12 includes or has access to one or more databases that provide server 16 with a basis for determining whether some or all of the multimedia content in a given outgoing multimedia message should be transcoded. For example, the ENUM conversion database and/or the carrier-listing database identifying transcoding actions and formats may be included in the transcoding system 18 of server 16. Alternatively, some or all of such database functionality may be implemented in supporting entity 20, which is accessible by transcoding system 18. Alternatively, one or both the transcoding system 18 and supporting entity 20 have access to a remote database server. Thus, MMS-C 12 has access to information on which it makes selective transcoding decisions for outgoing messages being sent by it to the specified destination networks.

In looking at such message sending operations, it may be helpful to describe a typical message routing sequence, starting with the assumption that a user of mobile station 22 wishes to send a multimedia message to another mobile station. Mobile station 22 sends the MMS message to MMS-C 12 via a supporting radio access network (RAN) not illustrated that is included in, or associated with, the illustrated portion of network 10. Relay 14 provides that message to server 16, which routes messages through the Internet using SMTP according to destination e-mail addresses.

A receiving server then sends a multimedia message notification to a Push Access Protocol (PAP) server in the destination network that functions as a Push Gateway for pushing messages to the receiving mobile device using the WAP forum standard. The PAP server sends a notification to the receiving mobile device 22 via a radio access network in the receiving network, and the receiving mobile station then pulls the MMS message from receiving server 18. The multimedia message thus is received in the receiving mobile station where it can be presented, played, or displayed to its user.

Of course, it should be understood that an outgoing multimedia message as selectively transcoded in accordance with the present invention does not necessarily originate from a mobile station associated with network 10. Indeed, the network operator may wish to send multimedia messages, e.g., advertisements, service information, etc., to one or more recipients.

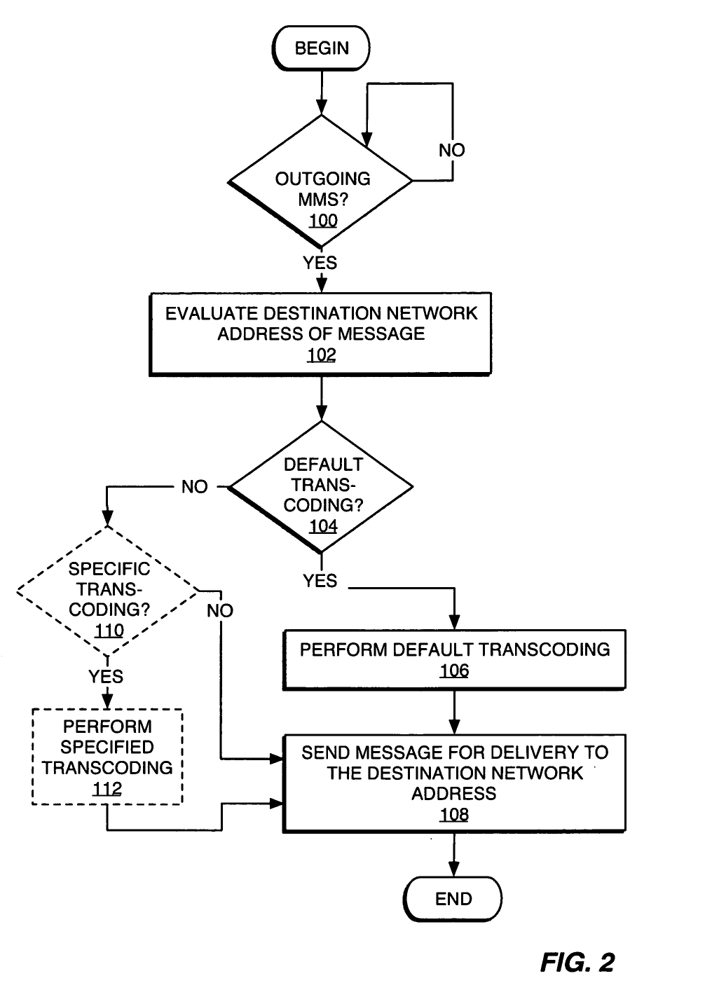

With the above in mind, and turning once again to the illustrations, FIG. 2 illustrates exemplary processing logic that may be implemented in server 16 in hardware, software, or any combination thereof, for carrying out an exemplary method of multimedia message processing. Transcoding processing at server 16 “begins” with a determination of whether there is an outgoing multimedia message to be processed (Step 100).

If so, processing continues with evaluation of the destination network address of the message (Step 102). If it is determined that default transcoding is desired before the message is sent for delivery to the destination network (Step 104), server 16 initiates or performs default transcoding (Step 106), wherein at least a portion of the multimedia content in the message is transcoded from a current coding format into a default coding format, and the (transcoded) message is then sent for delivery to the destination network corresponding to the messages address information.

If default transcoding it not desired, server 16 optionally may be configured to evaluate the destination address to determine whether specific transcoding should be performed before sending the message (Step 110). If specific transcoding is desired, then server 16 accesses locally or remotely stored information that indicates the particular (specific) coding format that should be used for transcoding multimedia content in the outgoing message, and carries out transcoding into the specified format (Step 112).

Evaluation of the destination address may comprise simply recognizing that an outgoing message is targeted to an email address, and server 16 (or supporting entity 20) may be configured to assume that default transcoding is desired for outgoing messages targeted to email addresses in general, or targeted to particular email addresses. Thus, in an exemplary embodiment, server 16 may be configured to perform default transcoding responsive to recognizing that an outgoing message is targeted for delivery to an Internet domain, e.g., for delivery to a subscriber of an Internet Service Provider (ISP), such as AMERICA ONLINE (AOL), EARTHLINK, ROADRUNNER, etc.

In this context, server 16 (or supporting entity 20) may be configured to use one or more encoding formats that are generally used for Internet delivery of multimedia content, such as WINDOWS Media Audio (WMA or .WAV) format, REAL Audio (.ra) format, Advanced Audio Coding (MC) format, etc. The benefit of default transcoding derives from the conversion of particular portions of the multimedia content from coding formats that may be native to the originating network, but that may not be widely used outside of similar types of networks.

By way of non-limiting example, if network 10 is a GSM network, the audio portion of multimedia content in outgoing messages likely is coded according to the AMR coding format used for over-the-air speech encoding, which is not widely supported in Personal Computer (PC) applications. Of course, other types of content (video, etc.) may be selectively transcoded, and default transcoding may be triggered only for certain portions of the multimedia content in outgoing messages, or different transcoding may be triggered for different portions of the message in dependence on the destination network addresses, e.g., transcode the video portion for some addresses, the audio portion for other addresses. Note, too, that some or all of the multimedia content may be transcoded into more than one default format to increase the likelihood that the ultimate recipient receives multimedia content in a compatible format.

If selective specific transcoding is implemented server 16 may transcode, or initiate such transcoding of, some or all of the multimedia content into one or more specified formats according to information stored in transcoding system 18 and/or stored in supporting entity 20. For example, transcoding system 18 (or supporting entity 20) may include a database or other listing that identifies specific transcoding formats to be used for particular destination network addresses. By way of non-limiting example, such format-specific transcoding may be based on identifying that the destination network address of a given message is another wireless communication network and looking up the particular format(s) to be used for transcoding the outgoing message to ensure compatibility with the targeted destination network.

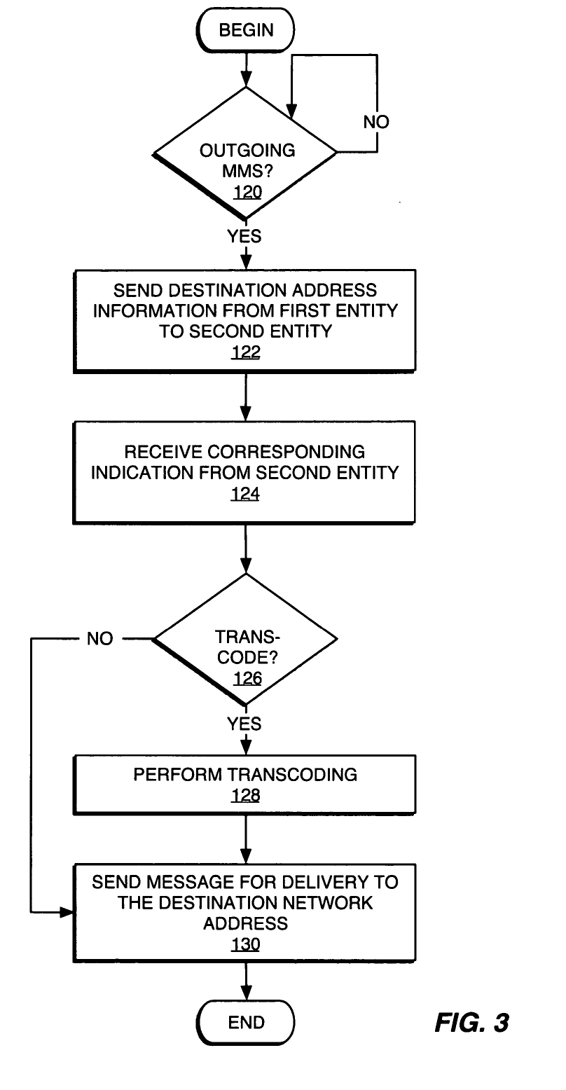

FIG. 3 illustrates processing logic for an exemplary configuration, wherein the transcoding system 18 within server 16 cooperates with supporting entity 20 to perform selective transcoding for outgoing multimedia messages. Processing begins with determining whether there is an outgoing multimedia message available (Step 120), i.e., whether there is a message to send MMS-C 12. If so, server 16 sends destination address information to the supporting entity 20 (Step 122), which in this instance is preferably configured as a transcoding database server.

Server 16 may derive destination address information from the message contents, e.g., from the message's header information, or it may send information to the supporting entity 20, such that the supporting entity 20 can determine the destination address information. In one embodiment, server 16 may simply send the message itself to the database server as the mechanism for providing the supporting entity 20 with the destination address information.

In any case, supporting entity 20 uses the destination address information to determine whether transcoding is desired for the outgoing message, and returns a corresponding indication that is received at the server 16 (Step 124). Server 16 selectively performs transcoding responsive to the returned indication (Step 126). That is, if transcoding is indicated, transcoding system 18 of server 16 transcodes at least a portion of the multimedia content in the outgoing message into one or more specified and/or default coding formats (Step 128), and sends the message for delivery according to the destination network address (Step 130). If transcoding is not indicated, server 16 simply sends the outgoing message (Step 130).

Note that supporting entity 20 not only may return an indication that transcoding is or is not desired, it also may return information identifying whether specific or default transcoding is desired in conjunction with returning the indication. More particularly, if specific transcoding is desired, i.e., transcoding into a format specified for the particular destination address, the supporting entity 20 may identify the specific transcoding format(s) to be used.

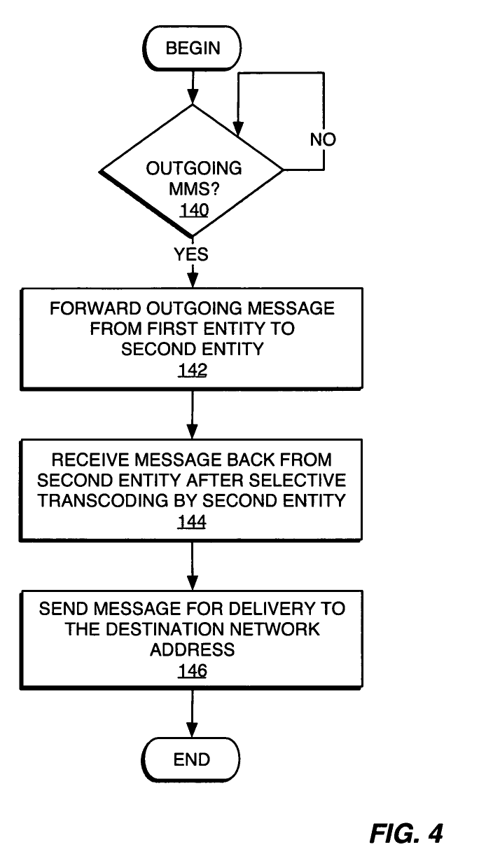

FIG. 4 illustrates yet another exemplary embodiment of processing logic. According to the illustrated processing logic, processing is similar to that described above for FIG. 3, but in this embodiment the supporting entity 20 is configured as a transcoding system like, or similar to, transcoding system 18 in server 16. Thus, some or all of transcoding system 18 may be omitted from server 16 to avoid duplicating functionality.

Regardless, processing begins with determining whether an outgoing message is available (Step 140). If so, server 16 forwards the outgoing message to the supporting entity 20 (Step 142). Supporting entity 20 determines whether selectively transcodes multimedia content in the message, and then returns the message to server 16 (Step 144). Upon receiving the message back from supporting entity 20, server 16 sends the message for delivery to the destination network address (Step 146).

Thus, according to the above embodiment, the supporting entity 20 offloads the transcoding function from MMS-C 12, and acts as supporting selective transcoding entity. As such, supporting entity 20 may be configured to include, or otherwise to access, a transcoding database that identifies the address for which transcoding is desired, and which may further identify whether default or specific transcoding is to be used for particular ones of those addresses. More generally, then, FIG. 4 illustrates a configuration wherein a first entity, e.g., the server 16, forwards the outgoing message to a second entity, e.g., the supporting entity 20, for selective transcoding, and subsequently receives that message back from the second entity for delivery to the destination network.

One advantage of using the supporting entity 20 in this configuration, or in the configuration of FIG. 3, is that the operator of network 10 is not necessarily obligated to provide or maintain the supporting entity 20. That is, although the supporting entity 20 could comprise part of network 10, it also may comprise an external entity that is maintained by a third-party operator for use by network 10. As such, the third-party operator would shoulder the burden of maintaining the transcoding database information, and could fulfill the useful role of consolidating and frequently updating such information.

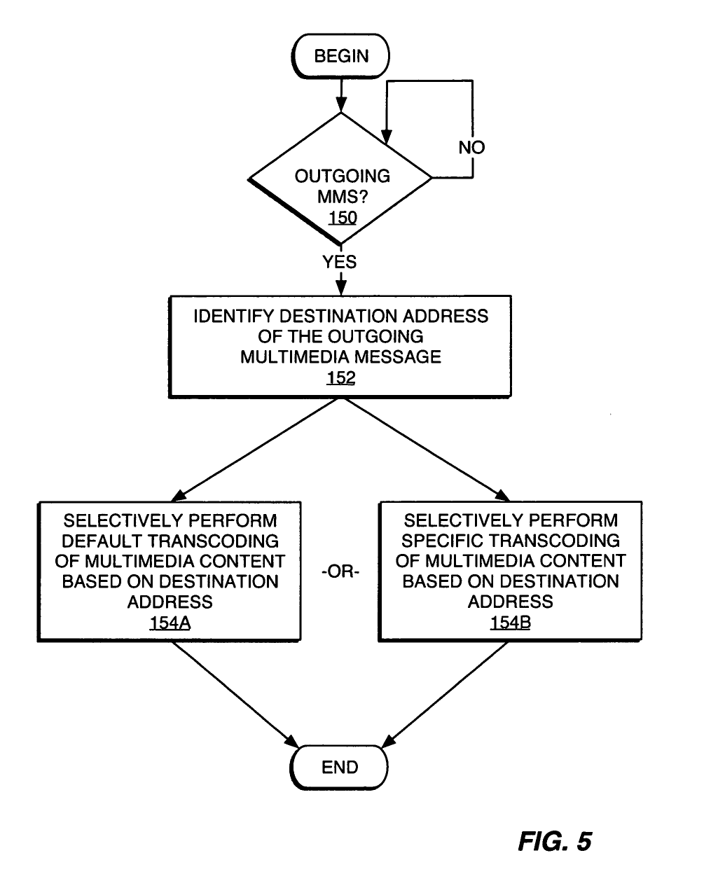

FIG. 5 illustrates yet another embodiment of exemplary processing logic that may be implemented with or without the use of supporting entity 20. As before, processing begins with a determination of whether an outgoing multimedia message is available for processing (Step 150). If so, server 16 or another entity identifies the destination address of the outgoing multimedia message (Step 152). Server 16 then performs transcoding of some or all of the multimedia content in the outgoing message as a function of the identified destination address, or initiates such performance. In this context, the transcoding is done based on one or more default formats (Step 154A), or done based on one or more specified formats (Step 154B).

As before, the distinction between transcoding and not transcoding can be based on determining whether the destination address is identified as belonging to a set of addresses for which transcoding is desired. Furthermore, it may similarly be determined whether, if transcoding is desired, whether the destination address is identified as belonging to a set of addresses for which specific transcoding formats are desired. Again, this may comprise determining whether the targeted address corresponds to some Internet domain, e.g., default coding, or whether it corresponds to a different type of wireless network, e.g., specific coding.

Those skilled in the art will recognize from the above details the many exemplary embodiments in which the present invention may be practiced, and that the present invention is amenable to a wide range of variations. For example, several such exemplary variations arise in the context of “dual-technology” wireless service provides. Earlier herein, it was noted that transcoding might include the conversion of a particular media type in an outgoing message into more than one coding format, such as to increase the likelihood that the message recipient receives content in a compatible format. One non-limiting example would be the conversion of AMR audio content into CELP audio content and into WMA, MP3, or other such format that enjoys broad compatibility in the context of Internet-based multimedia services.

However, the present invention contemplates additional or alternative provisions where an outgoing multimedia message is targeted to a recipient that is associated with more than one technology, e.g., a wireless service subscriber whose provider operates wireless networks based on more than one standard. As an example, a given wireless service provider may operate both cdma2000 and GSM networks. In such instances, identification of the destination network domain by MMS-C 12 for a given outgoing message may not necessarily provide it with an indication of which technology the targeted recipient mobile station is using. (Note that a particular MSISDN may be embodied in a “smart card” installable in either GSM-type or cdma2000 type mobile stations.) Further, a given mobile station may be designed to operate according to multiple wireless standards and thus it may be difficult to know at any given time which technology is being used by a mobile station that is targeted as the recipient of a multimedia message outgoing from MMS-C 12.

One approach to addressing such circumstances is to simply pick one or the other of the possible technologies and perform transcoding according to the selected technology if that is different than the current coding format(s) of the outgoing multimedia message. Another approach would be for MMS-C 12 to be programmed to recognize such multiple-technology ambiguities and transcode some or all of the multimedia content in the outgoing message into a default format that is selected based on its wide usage, i.e., actual or de facto “standard” Internet formats such as MP3, WAV, MPEG, etc. Yet another approach is for multi-technology wireless service providers to specify different domain addresses for each wireless technology they support. Thus, an outgoing message would be targeted to a cdma2000 domain, or a GSM domain, etc.

Of course, other variations of the present invention, including the aforementioned flexibility regarding the nature and location of the database(s) used to support selective transcoding of outgoing multimedia messages. As such, the present invention is not limited by the foregoing details, but rather is limited only by the following claims and their reasonable equivalents.

What is claimed is:

1. A method of processing multimedia messages outgoing from an originating network comprising:
selectively transcoding multimedia content in outgoing multimedia messages from a current format into a default format as a function of their destination network addresses; and
sending the messages according to their destination network addresses.

2. The method of claim 1, wherein selectively transcoding multimedia content in outgoing multimedia messages from a current format into a default format as a function of their destination network addresses comprises performing transcoding for messages targeted to email addresses.

3. The method of claim 1, wherein selectively transcoding multimedia content in outgoing multimedia messages from a current format into a default format as a function of their destination network addresses comprises not performing transcoding for messages not targeted to email addresses.

4. The method of claim 1, further comprising selectively transcoding multimedia content in outgoing multimedia messages from a current format into one or more specified formats as a function of their destination network addresses.

5. The method of claim 4, wherein selectively transcoding multimedia content in outgoing multimedia messages from a current format into one or more specified formats as a function of their destination network addresses comprises determining that an outgoing message is targeted to a wireless network domain, and transcoding at least a portion of the multimedia content in the message into a format specified for the targeted wireless network domain.

6. The method of claim 5, wherein determining that an outgoing message is targeted to a wireless network domain comprises identifying a targeted mobile telephone number for the outgoing message and identifying a name of the wireless network domain based on accessing an ENUM database that associates mobile station telephone numbers with particular wireless network domains.

7. The method of claim 5, wherein selectively transcoding multimedia content in outgoing multimedia messages from a current format into one or more specified formats as a function of their destination network addresses comprises transcoding audio content in the outgoing message from a first audio coding format associated with the originating communication network into a second audio coding format specified for the targeted wireless network domain.

8. The method of claim 7, wherein the originating network comprises either a GSM wireless communication network, or a cdma2000 wireless communication network, and the targeted wireless network domain corresponds either to a GSM wireless communication network, or to a cdma2000 wireless communication network.

9. The method of claim 1, wherein the originating network comprises a first wireless communication network, and wherein sending the messages according to their destination network addresses comprises sending the messages from one or more Multimedia Messaging Services (MMS) servers in the first wireless communication network.

10. The method of claim 1, wherein selectively transcoding multimedia content in outgoing multimedia messages from a current format into a default format as a function of their destination network addresses comprises performing default transcoding for outgoing messages targeted to Internet domains and not performing default transcoding for outgoing messages targeted to wireless network domains.

11. The method of claim 10, further comprising, for outgoing messages targeted to wireless network domains, determining whether transcoding is desired for a particular outgoing message targeted to a particular wireless network domain, and, if so, transcoding at least a portion of the multimedia content in that message into a format specified for that particular wireless network domain.

12. The method of claim 11, wherein determining whether transcoding is desired for a particular outgoing message targeted to a particular wireless network domain comprises determining whether a database identifies that particular network as one for which transcoding is desired.

13. The method of claim 12, further comprising identifying from information stored in the database the format specified for that particular network.

14. The method of claim 1, wherein selectively transcoding multimedia content in outgoing multimedia messages from a current format into a default format as a function of their destination network addresses comprises, for a particular outgoing message, determining whether default transcoding is desired based on the destination network address of that message, and if default transcoding is not desired, determining whether specified transcoding is desired based on determining whether a domain database indicates that specified transcoding is desired for the destination network address of that message.

15. A method of processing multimedia messages outgoing from an originating network comprising:
sending destination address information for an outgoing multimedia message from a first entity to a second entity;
receiving at the first entity a corresponding indication from the second entity as to whether multimedia content transcoding is desired for the message;
selectively performing transcoding at the first entity based on the indication; and
sending the message from the first entity for delivery to the destination address.

16. The method of claim 15, wherein the second entity is external to the originating network.

17. The method of claim 15, wherein sending destination address information for an outgoing multimedia message from a first entity to a second entity comprises forwarding the message from the first entity to the second entity, and wherein the message includes the destination address information.

18. The method of claim 15, wherein the originating network comprises a first wireless communication network, and wherein sending destination address information for an outgoing multimedia message from a first entity to a second entity comprises sending an indication of a destination mobile telephone number targeted by the message, or sending an indication of a destination network domain targeted by the message.

19. The method of claim 15, wherein receiving from the first entity a corresponding indication from the second entity as to whether multimedia content transcoding is desired for the message comprises receiving an indication from the second entity that identifies a desired format for transcoding at least a portion of the multimedia content in the message.

20. The method of claim 19, wherein selectively performing transcoding at the first entity based on the indication comprises determining whether the corresponding indication returned by the second entity indicates that transcoding is desired and, if so, transcoding at least a portion of the multimedia content in the message into the desired format.

21. The method of claim 15, wherein sending the message from the first entity for delivery to the destination address comprises sending the message to a multimedia server in a destination network for subsequent delivery to a targeted recipient.

22. A method of processing multimedia messages outgoing from an originating network comprising:
forwarding an outgoing multimedia message from a first entity to a second entity;
receiving the message back from the second entity at the first entity, after the second entity has subjected the message to selective transcoding of multimedia content in the message; and
sending the message from the first entity for delivery to the destination address.

23. The method of claim 22, wherein the second entity is external to the originating network.

24. The method of claim 22, further comprising, at the second entity, selectively performing transcoding of multimedia content in the message and then returning the message to the first entity.

25. The method of claim 24, wherein selectively performing transcoding of multimedia content in the message comprises determining whether transcoding is desired for the message based on a destination address of the message and, if transcoding is desired, transcoding at least a portion of multimedia content in the message from a first coding format into a second coding format.

26. A method of processing multimedia messages outgoing from an originating network comprising:
identifying a destination address of an outgoing multimedia message;
selectively performing default transcoding of multimedia content in the message based on identifying the destination address as one for which default transcoding is indicated;
selectively performing specified transcoding of multimedia content in the message based on identifying the destination address as one for which specified transcoding is indicated; and
sending the message for delivery to the destination address.

27. The method of claim 26, wherein sending the message for delivery to the destination address comprises sending the message to a multimedia server in a destination network for delivery by that multimedia server to a targeted recipient of the message.

28. The method of claim 26, wherein identifying the destination address as one for which default transcoding is indicated comprises recognizing that the destination address corresponds to an Internet email address.

29. The method of claim 26, wherein identifying the destination address as one for which specified transcoding is indicated comprises recognizing that the destination address corresponds to a wireless communication network for which transcoding is desired.

30. The method of claim 29, further comprising transcoding at least a portion of the multimedia content in the message from a current coding format into a specified coding format, and wherein the specified coding format is indicated for the destination address.

31. A multimedia message center for processing multimedia messages outgoing from an originating network comprising a server configured to selectively transcode multimedia content in outgoing multimedia messages from a current format into a default format as a function of their destination network addresses, and send the messages according to their destination network addresses.

32. A multimedia message center for processing multimedia messages outgoing from an originating network comprising:
a multimedia server configured to send destination address information for an outgoing multimedia message to a database server, and to receive an indication back from the database server as to whether multimedia content transcoding is desired for the message;
said multimedia server comprising a first circuit configured selectively to perform transcoding based on the indication, and a second circuit configured to send the message for delivery to the destination address.

33. A multimedia message center for processing multimedia messages outgoing from an originating network comprising a multimedia server configured to forward an outgoing multimedia message to a transcoding system, to receive the message back after the transcoding system has subjected the message to selective transcoding of multimedia content in the message, and to send the message from the first entity for delivery to the destination address.
